(19) United States
(12) Patent Application Publication
(10) Pub. No.: US 2005/0227841 A1
(43) Pub. Date: Oct. 13, 2005

(54) Case having a device for locking handle of knife

(76) Inventor: Yaw-Der Hwang, Taichung (TW)

Correspondence Address: LAW OFFICE OF LIAUH & ASSOC., 4224 WAIALAE AVE, STE 5-388, HONOLULU, HI, 96816, US

(21) Appl. No.: 10/823,491

(22) Filed: Apr. 12, 2004

(51) Int. Cl. B23Q 3/157

(52) U.S. Cl. 483/59; 211/70.6

(57) ABSTRACT

A hollow, cylindrical case comprises an upper seat, a cavity below the seat, and a lower channel. A locking device adopting an external locking mode comprises a plate secured onto the seat, the plate including a central hole, and a plurality of legs extended downwardly from the edge of the hole, each leg having an inwardly extended latched piece. Inserting a projection of a handle of a knife used in machining into the cavity and forcing through a channel surrounded by the latched pieces will move the latched pieces inwardly to lock a shoulder between the projection and the handle. An external locking mode can also be carried out in another embodiment. The invention can reliably secure the knifes in a storage.

### BACKGROUND OF THE INVENTION

1. Field of the Invention

The present invention relates to locking devices and more particularly to a case having a simple, inexpensive device for locking handle of knife used in machining.

2. Description of Related Art

Conventionally, a storage for knifes used in machining comprises a plurality of cases for storing handles of knifes. Also, a device is formed in the case for locking the handle of a knife. A conventional knife comprises a top projection 8 which is locked in the case 1 in an external locking mode as shown in FIGS. 1 and 2. A cavity 2 is provided in a hollow, cylindrical portion of the case 1. A lengthwise hole 3 is perpendicular to and across the cavity 2. A spring depressible member is provided in either part of the hole 3 and comprises an outer screw 6 flush with an outer surface of the case 1, a steel ball 4 partially projected from a narrow opening into the cavity 2, and a spring 5 biased between the steel ball 4 and the screw 6. For storage, the projection 8 of the handle 7 inserts into the cavity 4 and forces through a gap between the steel balls 4. Once passed the gap, the steel balls 4 move inwardly to lock the shoulder between the enlarged projection 8 and main body of the handle 7 due to the expansion of the springs 5.

However, the prior art suffered from several disadvantages. For example, the precision of the narrow opening in either part of the hole 3 is required to be very high. Otherwise, the balls 4 may either project too much or too little (see an enlarged portion in a lower part of FIG. 1), resulting in a compromise of the desired locking effect. Also, the springs 5 are required to be sufficiently strong and reliable. Both of the above can greatly increase the manufacturing cost.

Taiwanese Patent Published No. 88,216,006 entitled “Case Having an Improved Device for Locking Handle of Knife” is shown in FIGS. 3 and 4. As shown, an intermediate channel 10 is provided in communication with the hollow, cylindrical lower portion of the case 9 and a top recess. The channel 10 comprises a top enlarged cavity 11 with a spring ring 12 seated thereon. A hollow plate 13 is provided on the bottom of the recess for covering a top of the cavity 11. For storage, the projection 16 of the handle 15 inserts through the channel 10, the ring 12, and the hole 14 of the plate 13 until the shoulder of the enlarged projection 16 is locked by the ring 12 due to the compression of the ring 12.

It is simple to manufacture as compared to the first prior art. However, this prior art still suffered from several disadvantages. For example, the provision of the plate 13 and the ring 12 can increase the manufacturing cost. Also, the precision of the hole 14 is required to be very high (i.e., precisely aligned with the channel 10 and the ring 12). Otherwise, the projection 16 cannot be reliably locked.

Another Taiwanese Patent Published No. 88,212,906 entitled “Case Having Device for Locking Handle of Knife in an Internal Locking Mode” is shown in FIGS. 5 and 6. As shown, a recess 19 is provided in a lower portion of the hollow cylinder 18 of case 17. An internal receptacle 20 is threadedly fastened in the cylinder 18. The receptacle 20 comprises an internal block 23, a spring 24 for pushing the block 23 downwardly, and two steel balls 22 biased by the block 23 to partially project from two opposite lower openings 21. For storage, the top projection 27 of the handle 26 inserts into the recess 19 to pass the steel balls 22 and a cylindrical gap between the inner wall of the cylinder 18 and the receptacle 20. Once passed the gap, the steel balls 22 move outwardly to lock an internal shoulder of the projection 27 due to the downward movement of the block 23 caused by the expansion of the spring 24. However, the prior art still suffered from several disadvantages. For example, the precise positioning of the receptacle 20 is required. Also, the relative positioning of the steel balls 22 and the openings 21 is required to be very high. Otherwise, the projection 27 cannot be reliably locked. Both of the above can greatly increase the manufacturing cost. Thus, the need for improvement still exists.

### SUMMARY OF THE INVENTION

It is an object of the present invention to provide a case comprising a hollow, cylindrical portion including an upper seat, a cavity below the seat, and a lower channel; and a locking device including a plate secured onto the seat, the plate including a central hole, and a plurality of legs extended downwardly from the edge of the hole, each leg having an inwardly extended latched piece, whereby inserting a projection of a handle of a knife into the cavity and forcing through a channel surrounded by the latched pieces will move the latched pieces inwardly to lock a shoulder between the projection and the handle. By utilizing the present invention, it is possible of carrying out a simple assembly, precise positioning, and reliable locking, and greatly reducing the manufacturing cost.

It is another object of the present invention to provide a case comprising a hollow, cylindrical portion including an upper cavity, a seat on a bottom of the cavity, the seat having a central channel open to a bottom of the case; and a locking device including a plate secured onto the seat, the plate including a central hole, and a plurality of legs extended downwardly from the edge of the hole, each leg having an outwardly extended latched piece, whereby inserting a hollow protrusion of a handle of a knife into the case and forcing the latched pieces to insert into protrusion will move the latched pieces outwardly to lock a shoulder between an enlarged portion of a bore of the protrusion and a narrow end portion of the bore thereof.

The above and other objects, features and advantages of the present invention will become apparent from the following detailed description taken with the accompanying drawings.

### BRIEF DESCRIPTION OF THE DRAWINGS

FIG. 1 is a sectional view of a conventional case having a locking device;

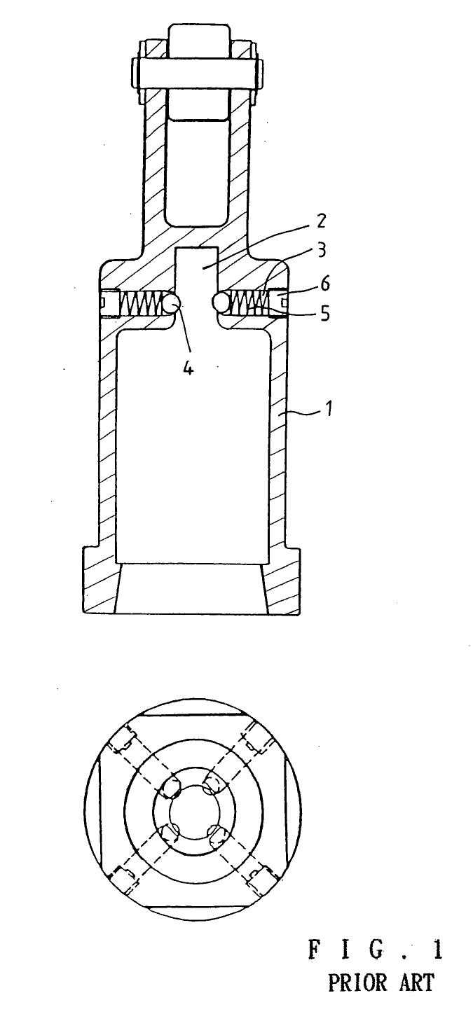

FIG. 2 is a sectional view of FIG. 1 showing the projection of the handle locked in the case;

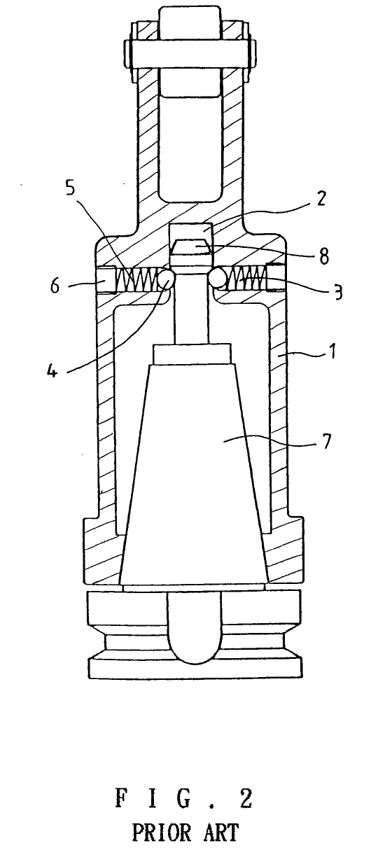

FIG. 3 is a sectional view of another conventional case having a locking device;

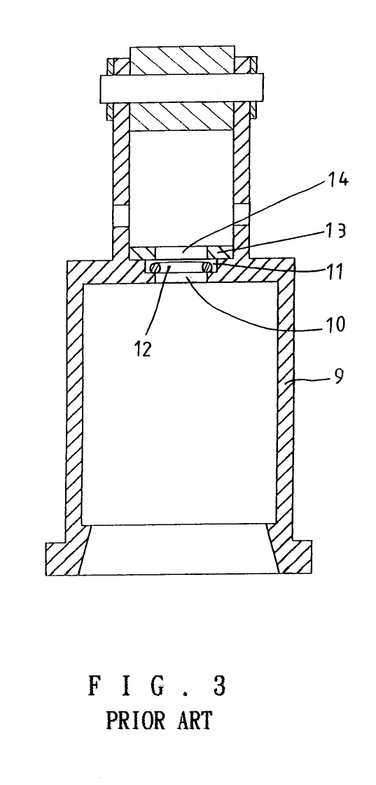

FIG. 4 is a sectional view of FIG. 3 showing the projection of the handle locked in the case;

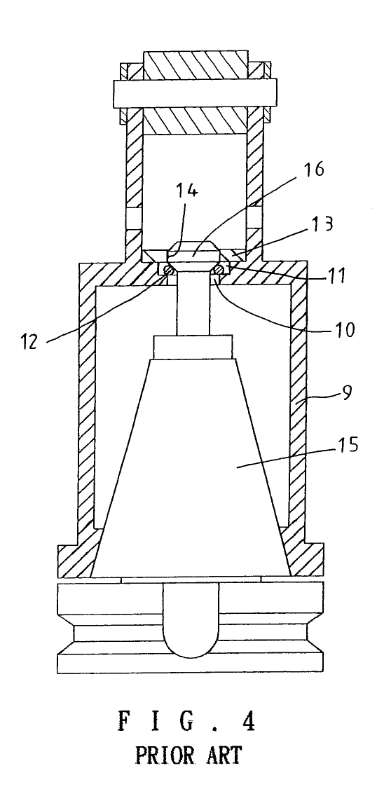

FIG. 5 is a sectional view of a further conventional case having a locking device;

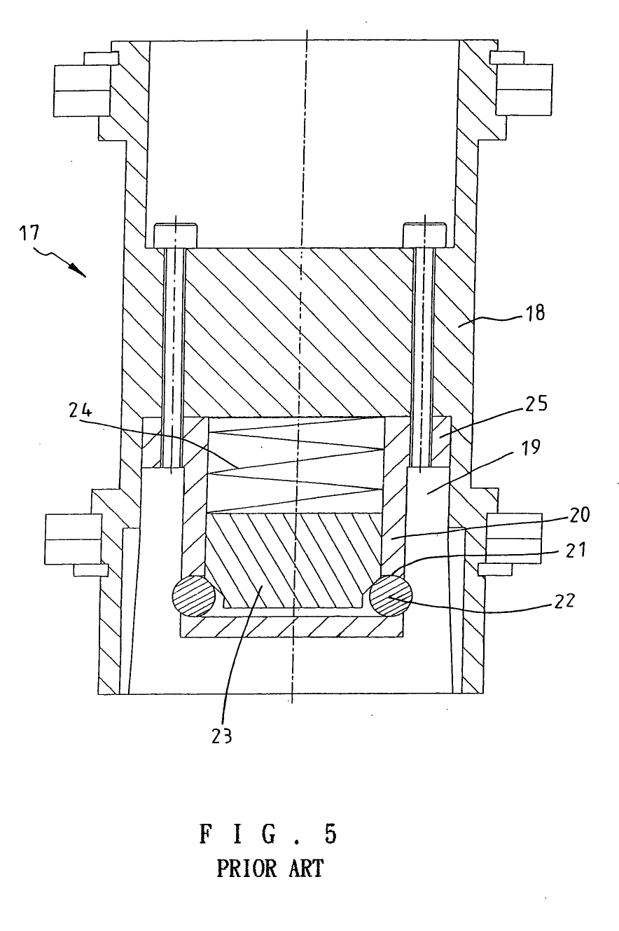

FIG. 6 is a sectional view of FIG. 5 showing the projection of the handle locked in the case;

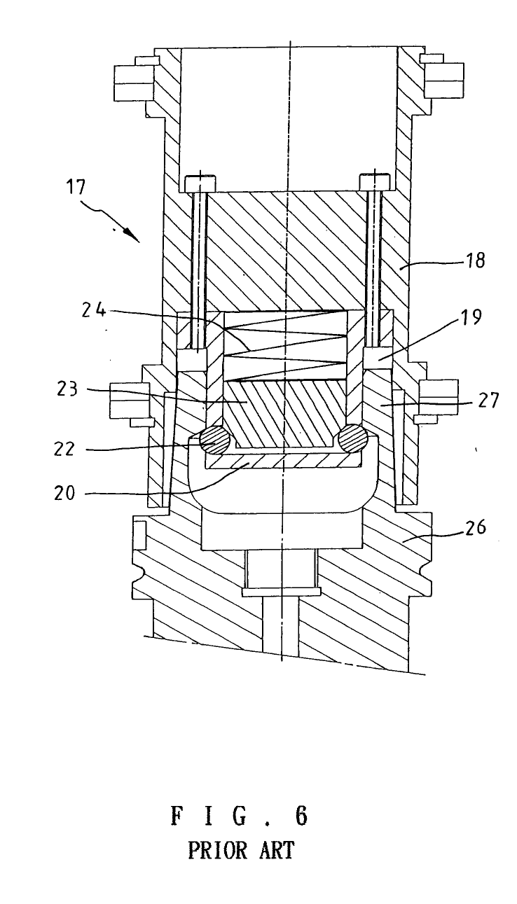

FIG. 7 is a broken away exploded view of a first preferred embodiment of case having a device for locking handle of knife in an external locking mode according to the invention;

FIG. 8 is a sectional view of the assembled case in FIG. 7;

FIG. 9 is a view schematically showing a handle of knife to be fastened by the case in FIG. 8;

FIG. 10 is a sectional view showing the fastened handle in FIG. 9;

FIG. 11 is a broken away exploded view of a second preferred embodiment of case having a device for locking handle of knife in an internal locking mode according to the invention;

FIG. 12 is a sectional view of the assembled case in FIG. 11;

FIG. 13 is a sectional view showing a handle of knife to be fastened by the case in FIG. 12; and

FIG. 14 is a sectional view showing the fastened handle in FIG. 13.

### DETAILED DESCRIPTION OF THE PREFERRED EMBODIMENTS

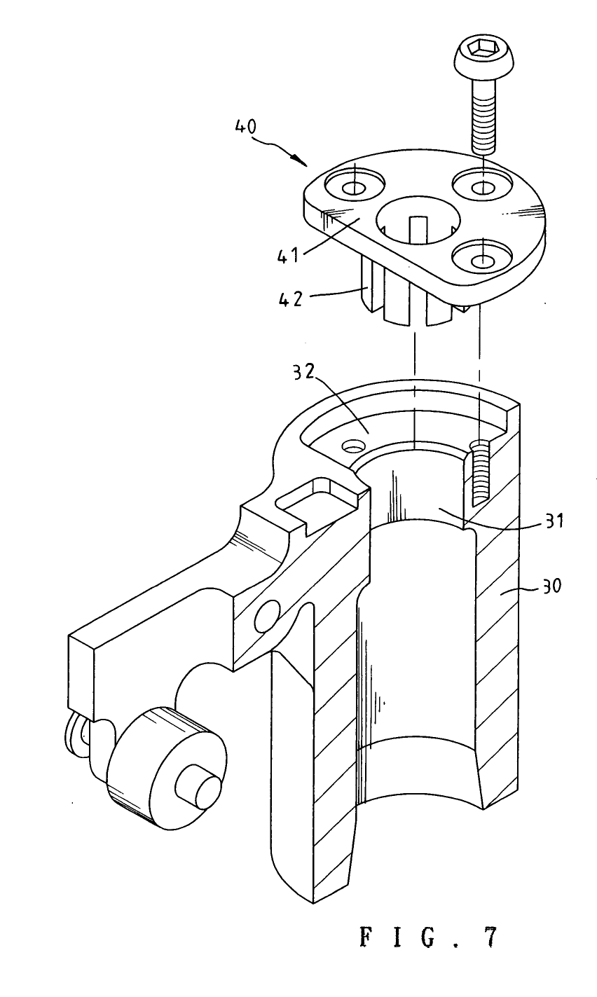

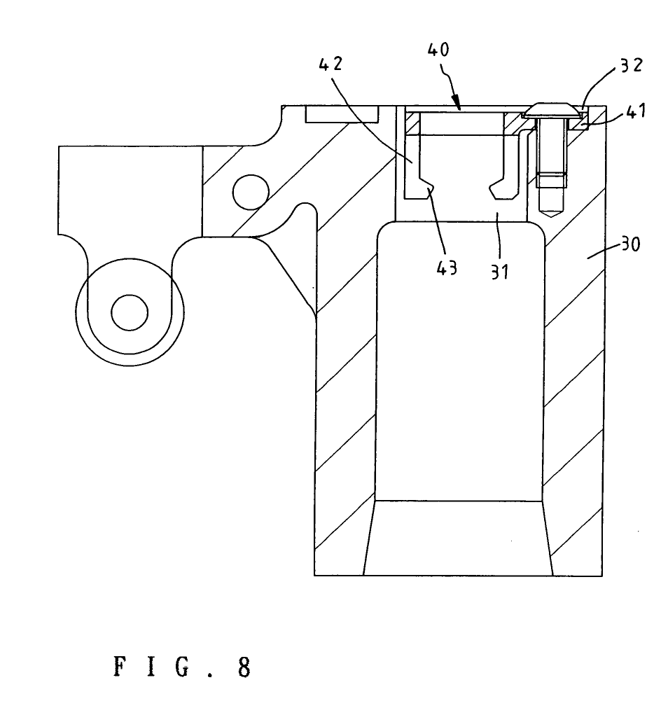

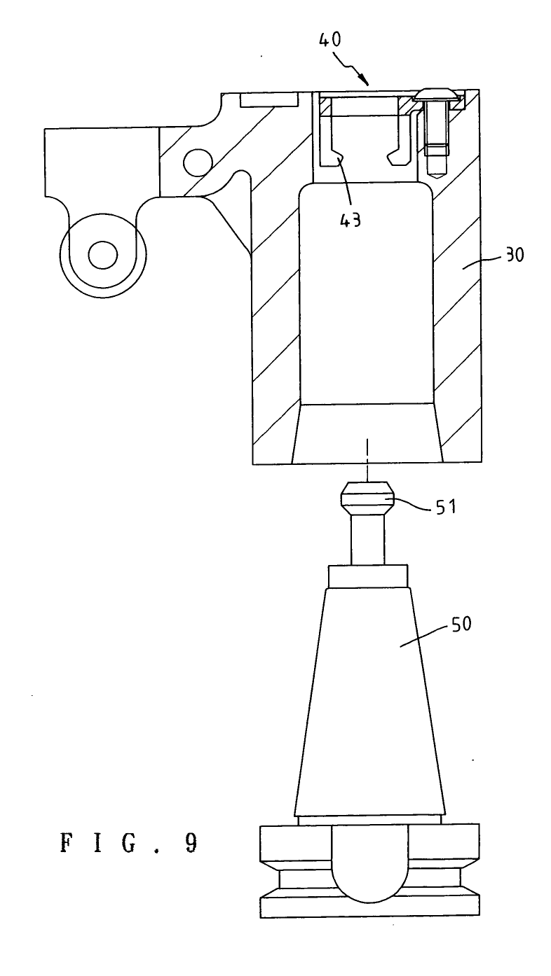

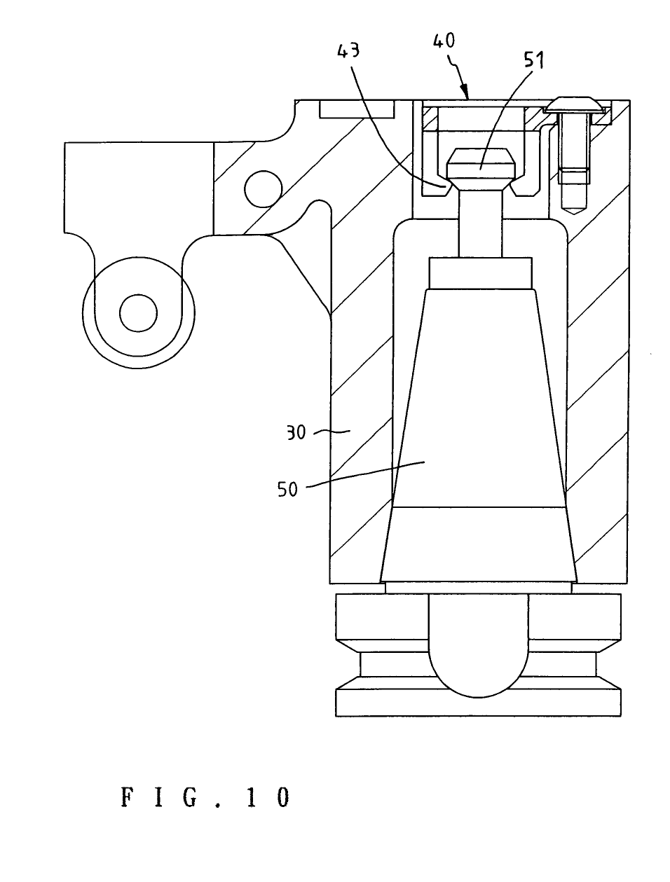

Referring to FIGS. 7 to 10, there is shown a first preferred embodiment of case 30 having a locking device adopted an external locking mode in accordance with the invention. A cavity 31 is provided in an upper portion of the hollow, cylindrical case 30. An enlarged substantially half circular seat 32 is provided on top of the cavity 31. An integral locking device 40 comprises a substantially half circular plate 41 having a central hole and three equally spaced apertures around the hole, and a plurality of legs 42 extended downwardly from the circular edge of the hole, each leg 42 having an inwardly extended latched piece 43. In assembly, three screws are driven through the apertures into threaded hole on the seat 32 for fastening the plate 41 on the seat 32. For storage, a projection 51 of a handle 50 is inserted into the cavity 31 and is forced through a channel surrounded by the latched pieces 43 because the projection 51 has a diameter larger than that of the channel. Once passed the channel, the latched pieces 43 move inwardly to lock the shoulder between the enlarged projection 51 and the handle 50 due to the flexibility of the latched pieces 43.

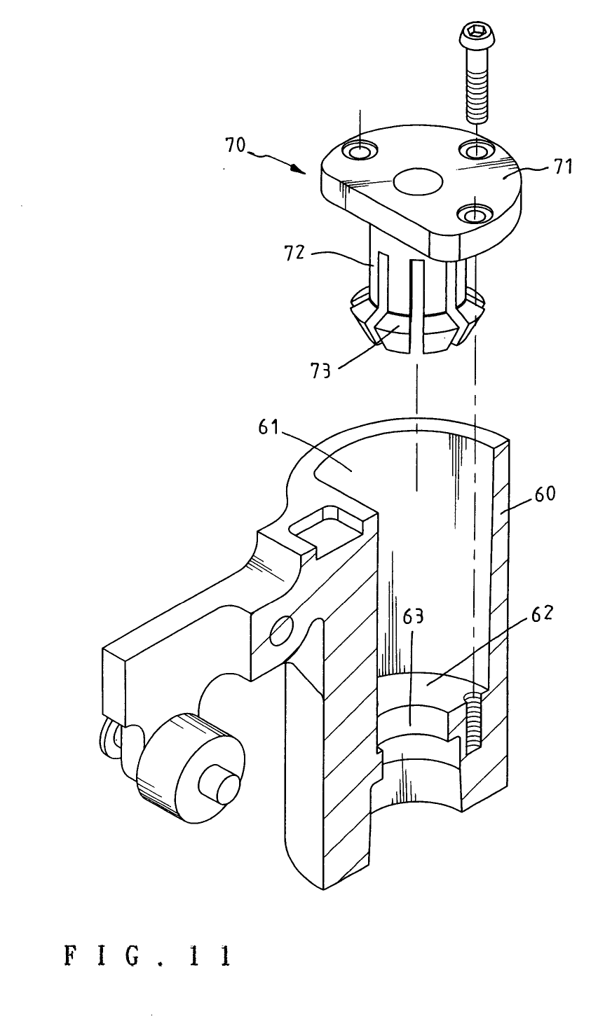

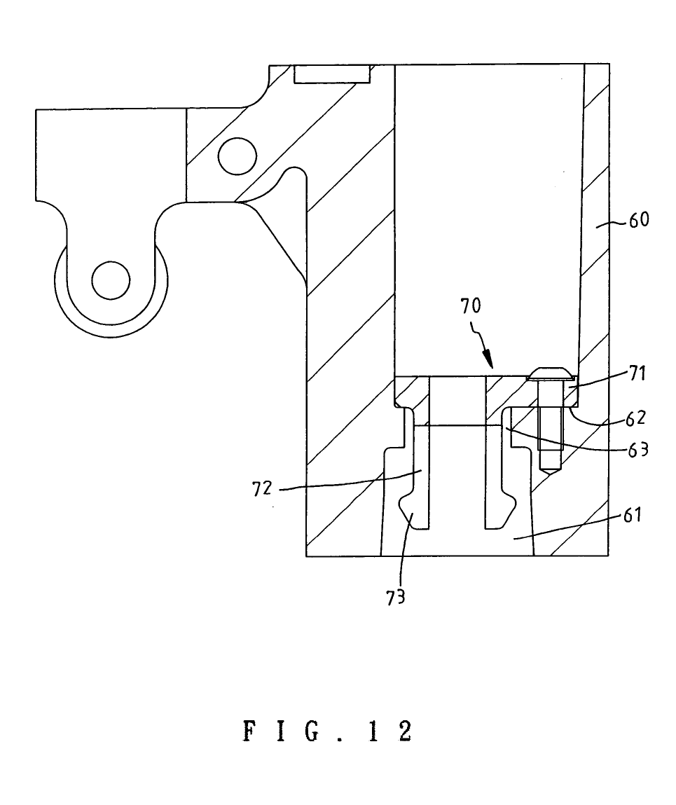

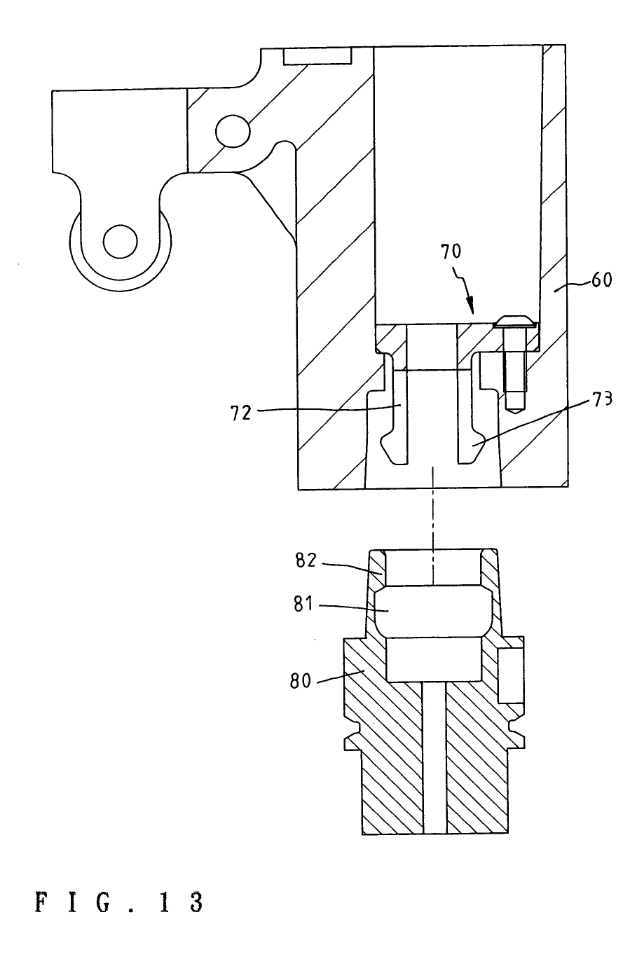

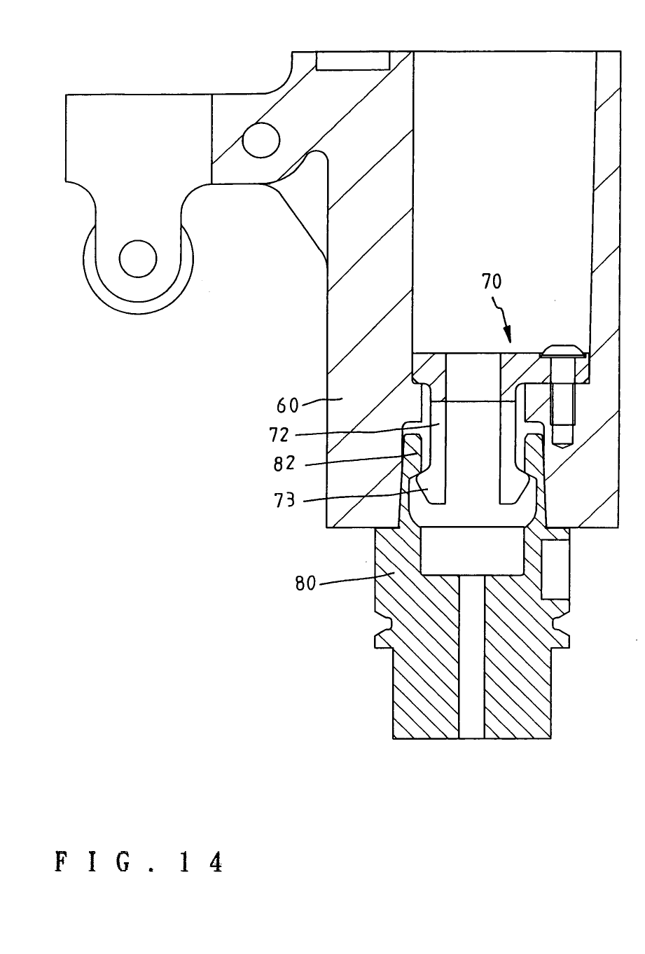

Referring to FIGS. 11 to 14, there is shown a second preferred embodiment of case having a locking device adopted an internal locking mode in accordance with the invention. The differences between these two preferred embodiments, i.e., the characteristics of the second preferred embodiment are detailed below. The hollow, cylindrical case 60 comprises a cavity 61 provided in upper and intermediate portions. The cavity 61 has a section of substantially half circle. A seat 62 has a central channel 63 open to the bottom of the case 60. An integral locking device 70 comprises a substantially half circular plate 71 having a central hole and three equally spaced apertures around the hole, and a plurality of legs 72 extended downwardly from the circular edge of the hole, each leg 72 having an outwardly extended latched piece 73. In assembly, three screws are driven through the apertures into threaded hole on the seat 62 for fastening the plate 71 on the seat 62. A handle 80 comprises a tunnel 81 open to one end. The tunnel 81 has a fastening end 82 having a narrow bore (i.e., smaller than an outer diameter of a circle formed by the latched pieces 73). For storage, the end portion of the handle 80 is inserted into the case 60 to force the latched pieces 73 to insert into the tunnel 81 by passing the fastening end 82. Once the latched pieces 73 passing the fastening end 82, the latched pieces 73 move outwardly to lock the shoulder between the tunnel 81 and the narrow bore of the fastening end 82 due to the flexibility of the latched pieces 73.

While the invention herein disclosed has been described by means of specific embodiments, numerous modifications and variations could be made thereto by those skilled in the art without departing from the scope and spirit of the invention set forth in the claims.

1. A case, comprising:
a hollow, cylindrical portion including an upper seat, a cavity below the seat, and a lower channel; and
a locking device including a plate secured onto the seat, the plate including a central hole, and a plurality of legs extended downwardly from the edge of the hole, each leg having an inwardly extended latched piece,
whereby inserting a projection of a handle of a knife into the cavity and forcing through a channel surrounded by the latched pieces will move the latched pieces inwardly to lock a shoulder between the projection and the handle.

2. The case of claim 1, wherein the projection has a diameter larger than that of the channel.

3. The case of claim 1, wherein each of the plate and the seat is substantially half circular.

4. A case, comprising:
a hollow, cylindrical portion including an upper cavity, a seat on a bottom of the cavity, the seat having a central channel open to a bottom of the case; and
a locking device including a plate secured onto the seat, the plate including a central hole, and a plurality of legs extended downwardly from the edge of the hole, each leg having an outwardly extended latched piece,
whereby inserting a hollow protrusion of a handle of a knife into the case and forcing the latched pieces to insert into protrusion will move the latched pieces outwardly to lock a shoulder between an enlarged portion of a bore of the protrusion and a narrow end portion of the bore thereof.

5. The case of claim 4, wherein the narrow end portion of the bore of the protrusion has a diameter smaller than an outer diameter of the latched pieces.

6. The case of claim 4, wherein each of the plate and the seat is substantially half circular.
